(19) United States
(12) Patent Application Publication
(10) Pub. No.: US 2011/0111293 A1
(43) Pub. Date: May 12, 2011

(54) METHOD FOR PRODUCING NEGATIVE ELECTRODE FOR LITHIUM ION BATTERY AND LITHIUM ION BATTERY

(76) Inventors: Yasutaka KOGETSU, Osaka (JP); Hitoshi Katayama, Osaka (JP)

(21) Appl. No.: 12/902,862

(22) Filed: Oct. 12, 2010

(30) Foreign Application Priority Data
Nov. 6, 2009 (JP) 2009-254906

(51) Int. Cl. H01M 4/139; H01M 4/13; H01M 2/14

(52) U.S. Cl. 429/209; 29/623.1; 429/247

(57) ABSTRACT

A method for producing a negative electrode for a lithium ion battery includes the steps of: (1) preparing a negative electrode plate and a negative electrode lead, the negative electrode plate comprising a current collector and a thin-film negative electrode active material layer including an alloyable active material; (2) clamping the negative electrode plate and the negative electrode lead between a pair of welding jigs comprising a first plate and a second plate, in such a manner that a surface of the thin-film negative electrode active material layer and a surface of the negative electrode lead overlap and that a welding region including a welding end face is exposed; and (3) generating an arc discharge toward the welding region to melt the welding region. The welding jigs have, along the welding region, a shape which restricts expansion of the volume of the welding region due to the arc discharge.

### FIELD OF THE INVENTION

The invention relates to a method for producing a negative electrode for a lithium ion battery and a lithium ion battery. More particularly, the invention relates to an improvement in the method for connecting a negative electrode lead and a negative electrode current collector of a negative electrode for a lithium ion battery including an alloyable active material.

### BACKGROUND OF THE INVENTION

Lithium ion batteries have high capacity and high energy density and can be easily made compact and light-weight. Thus, they are widely used as the power source for electronic devices, such as cellular phones, personal digital assistants (PDAs), notebook personal computers, video cameras, portable game machines and the like. A typical lithium ion battery has a positive electrode including a lithium cobalt composite oxide, a negative electrode including graphite, and a polyolefin separator.

The positive electrode and the negative electrode each comprise a current collector, an active material layer, and a lead. The active material layer is formed on a surface of the current collector, and the lead is welded to an exposed portion of the current collector where the active material layer is not formed. The lead is welded by resistance welding or ultrasonic welding. The exposed portion of the current collector is formed by forming an active material layer on the current collector surface while leaving a space therefor, or forming an active material layer on the current collector surface and removing a part of the active material layer.

Recently, with electronic devices having become multifunctional, the amount of electric power consumed thereby has increased. At the same time, it is desired to increase the time for which electronic devices can be continuously used on a single charge. Accordingly, lithium ion batteries are required to provide higher capacity, which has lead to active development of alloyable active materials with higher capacities than graphite. Representative alloyable active materials include silicon-based active materials such as silicon and silicon oxides.

A negative electrode including an alloyable active material usually includes a negative electrode current collector and a thin film of an alloyable active material (hereinafter may be referred to as a “thin-film negative electrode active material layer” formed on a surface of the negative electrode current collector by vapor deposition.

Various methods have been proposed for connecting a negative electrode lead to a negative electrode current collector with a thin-film negative electrode active material layer.

Japanese Laid-Open Patent Publication No. 2007-214086 (hereinafter referred to as “Patent Document 1”) discloses a negative electrode in which a laminate of a negative electrode plate and a negative electrode lead is irradiated with a laser to form a through-hole penetrating through the thickness of the laminate. When the laminate is irradiated with a laser, the negative electrode current collector and the negative electrode lead are melted and brought into contact with each other inside the resulting through-hole, so that the negative electrode current collector and the negative electrode lead are connected.

However, the connected portion of the negative electrode current collector and the negative electrode lead contains particles of an alloyable active material which have flown out of the thin-film negative electrode active material layer due to the laser irradiation. Since the alloyable active material has a high melting point, it is difficult to melt by laser irradiation. Thus, the bonding strength of the connected portion is low. Also, since the alloyable active material has a large electrical resistance, the particles of the alloyable active material present in the connected portion may make the conductivity of the connected portion low.

Japanese Laid-Open Patent Publication No. 2007-115421 (hereinafter referred to as “Patent Document 2”) discloses a negative electrode in which a negative electrode lead made of copper, a copper alloy, or a copper cladding material is connected to a surface of a thin-film negative electrode active material layer including an alloyable active material by resistance welding. In resistance welding, although the negative electrode current collector or the negative electrode lead may partially melt, the thin-film negative electrode active material layer does not melt since almost no current flows through the thin-film negative electrode active material layer. Thus, the negative electrode current collector and the negative electrode lead are not sufficiently connected.

### BRIEF SUMMARY OF THE INVENTION

A method for forming an exposed portion of a current collector when forming a thin film of an alloyable active material on a surface of the negative electrode current collector by vapor deposition is, for example, to form a masking layer at a predetermined position on a surface of a negative electrode current collector and remove the masking layer after a thin film is formed. The area from which the masking layer has been removed serves as an exposed portion of the current collector. This method requires complicated, additional operations such as the formation of the masking layer and the removal of the masking layer.

Another method for forming an exposed portion of a current collector is to partially remove a thin film of an alloyable active material, but this method is also very difficult. In particular, a thin film of a silicon-based active material is a glassy material with a high mechanical strength and firmly adheres to the negative electrode current collector surface. When the glassy thin film is removed from the negative electrode current collector, the negative electrode current collector may be damaged, so its current collecting performance and electrode performance may deteriorate.

That is, in the case of a negative electrode having a thin-film negative electrode active material layer including an alloyable active material, it is very complicated or difficult to connect a negative electrode current collector and a negative electrode lead efficiently and reliably.

It is therefore an object of the invention to provide a method for producing a negative electrode for a lithium ion battery having a thin-film negative electrode active material layer including an alloyable active material, wherein a negative electrode current collector and a negative electrode lead are connected reliably, and to provide a lithium ion battery including a negative electrode for a lithium ion battery produced by this method.

The method for producing a negative electrode for a lithium ion battery according to the invention includes the steps of:

(1) preparing a negative electrode plate and a negative electrode lead to be connected to the negative electrode plate, the negative electrode plate comprising a current collector and a thin-film negative electrode active material layer that is formed on a surface of the current collector and includes an alloyable active material;

(2) clamping the negative electrode plate and the negative electrode lead between a pair of welding jigs comprising a first plate and a second plate, in such a manner that a surface of the thin-film negative electrode active material layer and a surface of the negative electrode lead overlap and that a welding region including a welding end face comprising an end face of the negative electrode plate and an end face of the negative electrode lead is exposed; and

(3) generating an arc discharge toward the welding region to melt the welding region and connect the current collector and the negative electrode lead by arc welding, mating faces of the first plate and the second plate of the welding jigs have, along the welding region, a shape which restricts expansion of the volume of the welding region due to the arc discharge.

Also, the lithium ion battery according to the invention includes:

a positive electrode including a positive electrode current collector, a positive electrode active material layer formed on a surface of the positive electrode current collector, and a positive electrode lead connected to the positive electrode current collector;

a negative electrode produced by the above-mentioned method for producing a negative electrode for a lithium ion battery;

a separator interposed between the positive electrode and the negative electrode; and

a lithium-ion conductive non-aqueous electrolyte.

The method for producing a negative electrode for a lithium ion battery of the invention enables efficient and industrially advantageous production of a negative electrode for a lithium ion battery having a negative electrode current collector, a thin-film negative electrode active material layer including an alloyable active material, and a negative electrode lead, wherein the negative electrode current collector and the negative electrode lead are connected reliably. Also, the negative electrode produced by the production method of the invention has not only high bonding strength but also good conductivity between the negative electrode current collector and the negative electrode lead. Further, the lithium ion battery of the invention, which includes the negative electrode produced by the production method of the invention, has a high capacity, a high output, and good battery performance such as cycle characteristics and output characteristics.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a longitudinal sectional view showing a method for producing a negative electrode for a lithium ion battery in a first embodiment of the invention;

FIG. 2 is a longitudinal sectional view showing a method for producing a negative electrode for a lithium ion battery in a second embodiment of the invention;

FIG. 3 is a longitudinal sectional view schematically showing the structure of a lithium ion battery in a third embodiment of the invention;

FIG. 4 is a side perspective view schematically showing the configuration of an electron beam deposition device;

FIG. 5 is a perspective view schematically showing a method for preparing a sample which is used to measure the tensile strength of a negative electrode lead from a negative electrode current collector; and

FIG. 6 is a perspective view schematically showing a method for measuring the tensile strength of a negative electrode lead from a negative electrode current collector.

### DETAILED DESCRIPTION OF THE INVENTION

In the process of finding a solution to the above-mentioned problems, the present inventors have noted the configuration disclosed in Patent Document 2, in which the negative electrode current collector and the negative electrode lead are connected with the thin-film negative electrode active material layer including an alloyable active material therebetween. They have found a novel method of connecting a negative electrode plate including a negative electrode current collector and a thin-film negative electrode active material layer and a negative electrode lead made of a certain material by arc welding. They have found that this method allows not only the negative electrode current collector and the negative electrode lead but also the alloyable active material included in the thin-film negative electrode active material layer to melt and form an alloy layer, thereby making it possible to firmly connect the negative electrode current collector and the negative electrode lead with good conductivity.

According to this method, a negative electrode plate and a negative electrode lead are clamped by welding jigs in such a manner that a surface of the thin-film negative electrode active material layer and a surface of the negative electrode lead overlap and that a welding end face comprising an end face of the negative electrode plate and an end face of the negative electrode lead is exposed. An arc discharge is generated toward the welding end face, so that the welding region to which the energy of the arc discharge is applied is melted. When the melted portion thus formed solidifies, an alloy layer is formed between the negative electrode current collector and the negative electrode lead.

However, according to this method, the volume of the melted portion becomes partially too large and the dimensions of the alloy layer become unnecessarily large. As a result, problems tend to occur: for example, when a wound electrode assembly is produced, the dimensions and shape of the produced wound electrode assembly become out of specs; the produced wound electrode assembly has poor adhesion between the positive electrode or negative electrode and the separator; or the alloy layer damages the separator, thereby causing an internal short-circuit. Also, when a plurality of alloy layers are formed, the shape and/or dimensions of the alloy layers become uneven, which may make the above-mentioned problems more evident.

The reason why the volume of the melted portion becomes partially too large is not yet clear, but it is probably as follows. According to this method, the welding region is in contact with the surfaces of the welding jigs, so part of the energy released by the arc discharge is absorbed by the welding jigs. As a result, the energy of the arc discharge is not evenly distributed over the welding region, and the volume of the melted portion tends to become too large unevenly.

The present inventors have conducted further studies to prevent the dimensions of the alloy layer from becoming unnecessarily large and make the shape of the alloy layer constant. As a result, they have found that it is important to clamp a negative electrode plate and a negative electrode lead between welding jigs in such a manner that at least a part of the welding region including a welding end face comprising an end face of the negative electrode plate and an end face of the negative electrode lead is exposed. They have found the use of welding jigs of certain structure for clamping a negative electrode plate and a negative electrode lead as described above. Based on these findings, the present inventors have completed the invention.

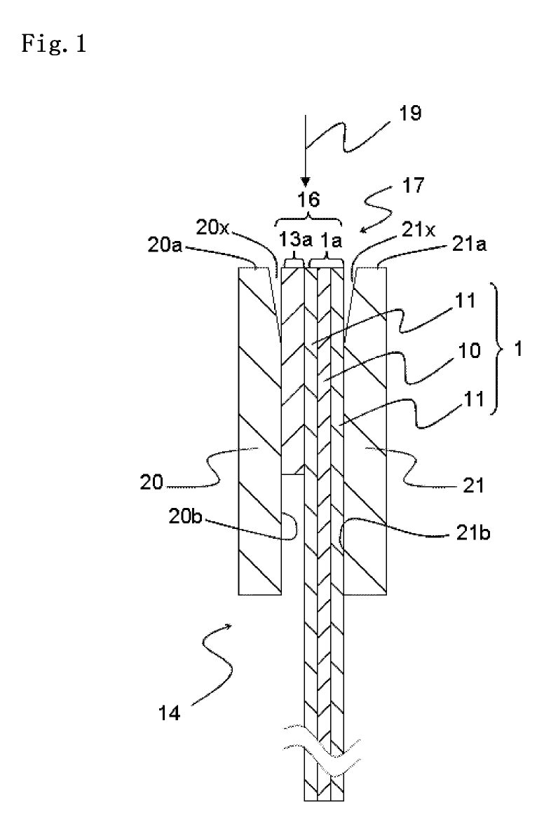

FIG. 1 is a longitudinal sectional view showing a method for producing a negative electrode for a lithium ion battery in a first embodiment of the invention. The method for producing a negative electrode for a lithium ion battery in a first embodiment (hereinafter referred to as the “production method of the first embodiment”) includes a step (1), a step (2), and a step (3). The respective steps are hereinafter described in details.

### [Step (1)]

In the step (1), a negative electrode plate 1 and a negative electrode lead 13 are prepared.

The negative electrode plate 1 includes a negative electrode current collector 10 and a thin-film negative electrode active material layer 11 formed on each face of the negative electrode current collector 10 in the thickness direction thereof. In this embodiment, the thin-film negative electrode active material layer 11 is formed on both faces of the negative electrode current collector 10 in the thickness direction, but may be formed on one face thereof.

The negative electrode current collector 10 can be a conductive substrate for a lithium ion battery, and is preferably a non-porous conductive substrate. The non-porous conductive substrate can be in the form of foil, a sheet, a film, etc. The conductive substrate can be made of a material such as stainless steel, titanium, nickel, copper, or a copper alloy. The thickness of the conductive substrate is 1 to 500 μm, preferably 1 to 50 μm, and more preferably 10 to 30 μm.

The thin-film negative electrode active material layer 11 includes an alloyable active material, and may contain other known negative electrode active materials than alloyable active materials, additives, etc. unless its characteristics are impaired. In a preferable embodiment, the thin-film negative electrode active material layer 11 is an amorphous or low-crystalline thin film including an alloyable active material and having a thickness of 3 to 50 μm.

The alloyable active material absorbs lithium by being alloyed with lithium during charge and releases lithium during discharge, at the potential of the negative electrode. The alloyable active material is not particularly limited, and can be a known one. It is preferably a silicon-based active material or a tin-based active material, and more preferably a silicon-based active material.

Examples of silicon-based active materials include silicon, silicon compounds, partially replaced silicon or silicon compounds, and solid solutions thereof. Examples of silicon compounds include silicon oxides, silicon carbides, silicon nitrides, and silicon alloys. Among them, silicon oxides are preferable.

Examples of silicon oxides include silicon oxides represented by the formula: SiOₐ where 0.05<a<1.95. Examples of silicon carbides include silicon carbides represented by the formula: SiC_{b} where 0<b<1. Examples of silicon nitrides include silicon nitrides represented by the formula: SiN_{c} wherein 0<c<4/3.

Silicon alloys are alloys containing silicon and at least one different element (A) selected from the group consisting of Fe, Co, Sb, Bi, Pb, Ni, Cu, Zn, Ge, In, Sn, and Ti. Partially replaced silicon or silicon compounds are compounds in which part of the silicon contained in silicon or silicon compounds is replaced with at least one different element (B) selected from the group consisting of B, Mg, Ni, Ti, Mo, Co, Ca, Cr, Cu, Fe, Mn, Nb, Ta, V, W, Zn, C, N, and Sn.

Examples of tin-based active material include tin, tin oxides, tin nitrides, tin alloys, tin compounds, and solid solutions thereof, and tin oxides are preferable. Examples of tin oxides include tin oxides such as SnO_{d} where 0<d<2 and SnO₂. Examples of tin alloys include a Ni—Sn alloy, a Mg—Sn alloy, a Fe—Sn alloy, a Cu—Sn alloy, and a Ti—Sn alloy. Examples of tin compounds include SnSiO₃, Ni₂Sn₄, and Mg₂Sn.

These alloyable active materials can be used singly or in combination.

The thin-film negative electrode active material layer 11 is formed on one surface or both surfaces of the negative electrode current collector 10 by vapor deposition. Examples of vapor deposition include vacuum deposition, sputtering, ion plating, laser ablation, chemical vapor deposition (CVD), plasma chemical vapor deposition, and thermal spraying. Among them, vacuum deposition is preferable.

For example, in an electron beam vacuum deposition device, the negative electrode current collector 10 is disposed vertically above a silicon target. The silicon target is irradiated with an electron beam to produce silicon vapor, so that the silicon vapor is deposited on a surface of the negative electrode current collector 10. As a result, the thin-film negative electrode active material layer 11 comprising silicon is formed on the surface of the negative electrode current collector 10. At this time, when oxygen or nitrogen is supplied into the electron beam vacuum deposition device, the thin-film negative electrode active material layer 11 comprising a silicon oxide or a silicon nitride is formed.

In this embodiment, the thin-film negative electrode active material layer 11 is formed as a solid film, but is not to be limited thereto. It may be formed in a pattern such as a lattice by vapor deposition, or may be formed as an aggregate of a plurality of columns.

The columns are formed so that they each include an alloyable active material, extend outwardly from the surface of the negative electrode current collector, and are spaced apart from one another. The height of the columns is preferably 3 μm to 30 μm. In this case, it is preferable to form a plurality of protrusions on the negative electrode current collector surface regularly or irregularly and form a column on the surface of each of the protrusions. The protrusions can be rhombic, circular, oval, triangular to octagonal, and the like in an orthographic projection from vertically above. Regular arrangements of the protrusions include a grid pattern, a lattice pattern, a houndstooth check pattern, a close-packed pattern, and the like. Also, the protrusions are formed on one surface or both surfaces of the negative electrode current collector.

The negative electrode lead 13 includes at least one metal or alloy selected from the group consisting of nickel, nickel alloys, copper, and copper alloys. Examples of nickel alloys include a nickel-silicon alloy, a nickel-tin alloy, a nickel-cobalt alloy, a nickel-iron alloy, and a nickel-manganese alloy. Examples of copper alloys include a copper-nickel alloy, a copper-iron alloy, a copper-silver alloy, a copper-phosphorus alloy, a copper-aluminum alloy, a copper-silicon alloy, a copper-tin alloy, a copper-zirconia alloy, and a copper-beryllium alloy.

Among them, in terms of increasing the bonding strength between the negative electrode current collector 10 and the negative electrode lead 13, nickel, copper, and a copper-nickel alloy are preferable, and copper is more preferable. Also, a cladding material comprising copper and nickel can also be used. The negative electrode lead 13 is produced by shaping such a metal or alloy into a common shape of a lead.

### [Step (2)]

In the step (2), using a pair of welding jigs 14 comprising a first plate 20 and a second plate 21, the negative electrode plate 1 and the negative electrode lead 13 are clamped between the first plate 20 and the second plate 21. The welding jigs 14 are produced by shaping a metal material such as copper into a predetermined shape. The negative electrode plate 1 and the negative electrode lead 13 are clamped between the welding jigs 14 in such a manner that a surface of the thin-film negative electrode active material layer 11 and a surface of the negative electrode lead 13 overlap and that a welding region including a welding end face 16 comprising an end face 1a of the negative electrode plate 1 and an end face 13a of the negative electrode lead 13 is exposed.

As used herein, “a surface of the thin-film negative electrode active material layer 11” refers to one face of the thin-film negative electrode active material layer 11 in the thickness direction. Also, “a surface of the negative electrode lead 13”, as used herein, refers to one face of the negative electrode lead 13 in the thickness direction. The whole surface of the thin-film negative electrode active material layer 11 and the whole surface of the negative electrode lead 13 do not need to overlap, and these surfaces can at least partially overlap and be in contact with each other.

In this embodiment, the end face 1a of the negative electrode plate 1 is, but is not limited to, an end face of the negative electrode plate 1 in the longitudinal direction. The end face 13a of the negative electrode lead 13 is, but is not limited to, an end face of the negative electrode lead 13 in the width direction. The end face 1a of the negative electrode plate 1 may be an end face in the longitudinal direction or width direction of the negative electrode plate 1. The end face 13a of the negative electrode lead 13 may be an end face in the longitudinal direction or width direction of the negative electrode lead 13.

Whether the end face 1a of the negative electrode plate 1 and the end face 13a of the negative electrode lead 13 should be made an end face in the longitudinal direction or width direction can be selected as appropriate, depending on the conditions such as the structure of the electrode assembly (wound, flat, layered, etc.), the form of the lithium ion battery (prismatic, cylindrical, flat, laminated film pack, coin, etc.), and the design (dimensions, capacity, use, etc.).

Also, when the negative electrode plate 1 and the negative electrode lead 13 are clamped between the welding jigs 14, it is preferable to dispose the negative electrode plate 1 and the negative electrode lead 13 so that the end face 1a of the negative electrode plate 1 and the end face 13a of the negative electrode lead 13 form a continuous flat plane, i.e., the flat welding end face 16. As used herein, the welding region including the welding end face 16 is a region of the negative electrode plate 1 and the negative electrode lead 13 to which the energy of an arc discharge, generated from a direction 19 perpendicular to the welding end face 16 under conditions described below, is applied.

The first plate 20 has a face 20b to mate with the second plate 21, and the second plate 21 has a face 21b to mate with the first plate 20. The mating faces 20b and 21b of the welding jigs 14 have, in at least a part of the area around the welding region, a shape which restricts expansion of the volume of the welding region due to arc discharge. The welding jigs 14 of this embodiment have a depression 17 which is formed by a first recess 20x of the first plate 20 and a second recess 21x of the second plate 21 when the negative electrode plate 1 and the negative electrode lead 13 are clamped between the first plate 20 and the second plate 21. The space inside the depression 17 has a shape which restricts expansion of the volume of the welding region.

The first recess 20x is formed from an end face 20a of the first plate 20 along the mating face 20b. In this embodiment, the first recess 20x is a notch that is tapered (more specifically, in the shape of a right-angled triangle) in a section. The section of the first recess 20x refers to a section in the thickness direction of the first plate 20. The second recess 21x is formed from an end face 21a of the second plate 21 along the mating face 21b, and faces the first recess 20x with the negative electrode plate 1 and the negative electrode lead 13 therebetween. In this embodiment, the second recess 21x is a notch that is tapered (more specifically, in the shape of a right-angled triangle) in a section. The section of the second recess 21x refers to a section in the thickness direction of the second plate 21.

When each of the first recess 20x and the second recess 21x is a notch that is tapered in a section, the dimensions of these notches are not particularly limited and can be selected as appropriate, depending on the thickness of the negative electrode current collector 10, the thin-film negative electrode active material layer 11, and the negative electrode lead 13, the kind and composition of the metal and semimetal elements contained therein, etc.

For example, when the negative electrode current collector 10 has a thickness of 1 to 50 μm, the thin-film negative electrode active material layer 11 has a thickness of 1 to 30 μm, and the negative electrode lead 13 has a thickness of 10 to 500 μm, the length along the end face 20a of the first plate 20 or the end face 21a of the second plate 21 in a section of the first recess 20x or the second recess 21x is preferably 0.1 to 0.6 mm, and the length along the mating face 20b of the first plate 20 or the mating face 21b of the second plate 21 in a section of the first recess 20x or the second recess 21x is preferably 0.2 to 0.6 mm. Also, it is preferable to form the first recess 20x and the second recess 21x so that they have the same dimensions.

The width of the depression 17 formed by the first recess 20x and the second recess 21x decreases as the distance from the end face 20a of the first plate 20 and the end face 21a of the second plate 21 increases. Thus, the space inside the depression 17 has a trapezoidal shape in a section. The sectional shape of the space inside the depression 17 in this embodiment is not limited to a trapezoid, and may be, for example, a triangle. Also, the space inside the depression 17 may be in the shape of a cone, a triangular pyramid, or the like.

As described above, due to the provision of the depression 17 in the welding jigs 14, expansion of the volume of the welding region caused by arc discharge is restricted, and the dimensions of the alloy layer formed by melting and resolidication of the welding region do not become too large. Also, the dimensions and shape of the alloy layer do not cause problems in fabricating a wound electrode assembly. Further, even when a plurality of alloy layers are formed, the dimensions and shape of the alloy layers become almost uniform. Hence, the dimensions of the wound electrode assembly fall within specs, and a decrease in the adhesion between the positive electrode or negative electrode and the separator and occurrence of an internal short-circuit resulting from the dimensions and shape of the alloy layers are significantly suppressed.

In addition, due to the provision of the depression 17 in the welding jigs 14, the welding region is melted almost completely. The welding region comprises the negative electrode current collector 10, the thin-film negative electrode active material layers 11, and the negative electrode lead 13, which include metal and semimetal (e.g., silicon) elements. When the welding region is melted almost completely, the metal and semimetal elements are almost homogeneously mixed and dispersed, and at least a part thereof is alloyed. As a result, the alloy layer formed by resolidification of the molten welding region has a uniform structure, and the mechanical strength and conductivity of the alloy layer are further improved. As a result, even when the dimensions of the alloy layer become small, the adhesion and conductivity between the negative electrode current collector 10 and the negative electrode lead 13 connected by the alloy layer become almost equivalent to those when the dimensions of the alloy layer become unnecessarily large.

When the welding region is melted unevenly, unnecessarily protruding portions are formed due to the partial difference in viscosity or the like, and the dimensions and shape of the alloy layer formed by resolidification of the welding region tend to vary. Also, an alloy layer having unnecessarily protruding portions tends to be formed. As a result, in producing a battery, it is necessary to provide an extra space inside the battery to prevent such protruding portions from causing an internal short-circuit. The extra space is an obstacle to high density battery design and high capacity battery design.

Although the reason for the above-mentioned effects is not yet clear, it is probably as follows.

In this embodiment, between at least a part of the welding region and the welding jigs 20 and 21, there are spaces, namely, the first recess 20x and the second recess 21x. Thus, at least a part of the welding region and the welding jigs 20 and 21 do not come into contact with each other therein. This prevents the energy of the arc discharge applied to the welding region from being absorbed by the first plate 20 and the second plate 21. As a result, the energy of the arc discharge is distributed almost uniformly over the welding region, and the welding region is melted uniformly.

Thereafter, the volume of the welding region expands due to melting, and the molten welding region comes into contact with the surface of the first plate 20 which faces the first recess 20x and the surface of the second plate 21 which faces the second recess 21x. At this time, at least a part of the energy of the welding region is absorbed by the first plate 20 and the second plate 21, but a partial change in shape is unlikely to occur, since the welding region has been already melted evenly. That is, expansion of the volume of the welding region due to melting, in particular, partial expansion, is regulated. Hence, the shape of the alloy layer formed by resolidification of the molten welding region reflects the shape of the space inside the depression 17, and partially protruding portions are not formed. Probably for this reason, an alloy layer with high mechanical strength, high conductivity, and a constant shape is formed.

### [Step (3)]

In the step (3), an arc discharge is generated toward the welding region including the welding end face 16 to melt the welding region and connect the negative electrode current collector 10 and the negative electrode lead 13 by arc welding.

Specifically, an electrode for arc welding (not shown) is disposed perpendicularly to the welding end face 16 comprising the end face 1a of the negative electrode plate 1 and the end face 13a of the negative electrode lead 13. Energy is released from the welding torch of the electrode for arc welding in the direction of the arrow 19. The energy released from the welding torch is applied to the welding end face 16. As a result, the welding region including the welding end face 16 is evenly melted and solidifies to form an alloy layer.

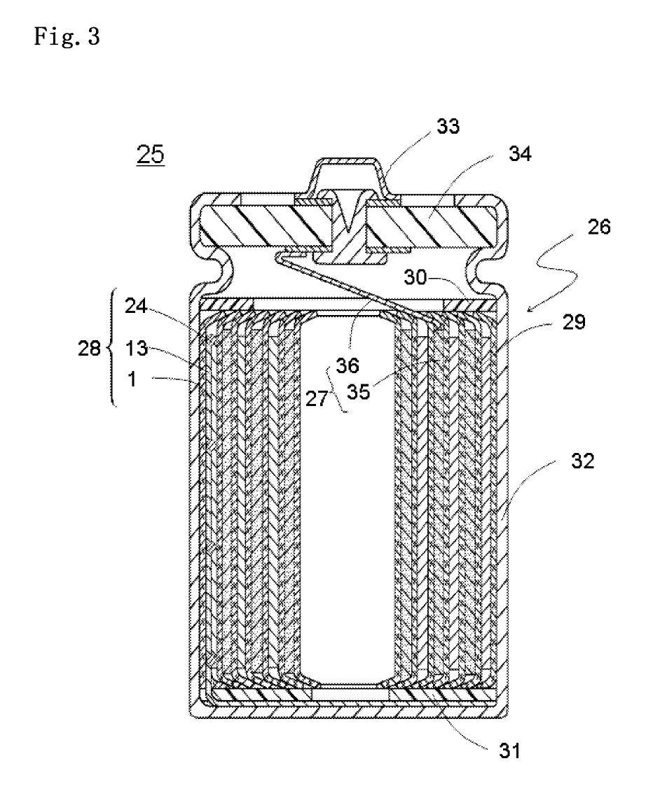

The electrode for arc welding may be moved in the width direction of the negative electrode plate 1 at predetermined intervals to perform an arc welding. In this case, a negative electrode 28 included in a lithium ion battery 25 illustrated in FIG. 3 is obtained. This negative electrode 28 has a plurality of alloy layers 24. Also, an arc welding may be performed continuously while moving the electrode for arc welding in the width direction of the negative electrode plate 1. In this case, the alloy layer 24 is formed on the almost entire region of one end of the negative electrode plate 1 in the longitudinal direction thereof so that it extends in the width direction thereof. Arc welding allows the alloy layer(s) 17 to be formed easily at desired location(s) of the negative electrode current collector 10 and the negative electrode lead 13.

Among arc welding methods, plasma welding and TIG (Tungsten Inert Gas) welding are preferable. In consideration of uniform dispersion of elements in the alloy layers 24, plasma welding is particularly preferable. It is believed that as the elements are dispersed more uniformly inside the alloy layers 24, the adhesion and conductivity between the negative electrode current collector 10 and the negative electrode lead 13 connected by the alloy layers 24 increase. Plasma welding and TIG welding are performed using a plasma welding machine and a TIG welding machine which are commercially available, respectively.

Plasma welding can be performed by suitably selecting conditions such as welding current value, welding speed (moving speed of welding torch), welding time, and the kind and flow rate of plasma gas and shielding gas. By selecting these conditions, the adhesion and conductivity between the negative electrode current collector 10 and the negative electrode lead 13 connected by the resulting alloy layers 24 can be controlled.

The welding current value is selected from the range of, for example, 1 A to 100 A. The sweep rate of the welding torch is selected from the range of, for example, 1 mm/sec to 100 mm/sec. Argon gas or the like is used as the plasma gas. The flow rate of plasma gas is selected from the range of, for example, 10 ml/min to 10 l/min. Argon, hydrogen, or the like can be used as the shielding gas. The flow rate of shielding gas is selected from the range of, for example, 10 ml/min to 10 l/min.

It should be noted that a part of the thin-film negative electrode active material layers 11 may remain unmelted in the alloy layers 24 depending on the conditions of arc welding. However, as long as arc welding is used to form the alloy layers 24, the thin-film negative electrode active material layers 11 remaining in the alloy layers 24 do not make the adhesion and conductivity between the negative electrode current collector 10 and the negative electrode lead 13 connected by the alloy layers 24 insufficient for practical use.

On the other hand, if resistance welding is performed in place of arc welding, a current flows through the negative electrode current collector 10 and the negative electrode lead 13, but does not flow through the thin-film negative electrode active material layers 11, since the thin-film negative electrode active material layers 11 include an alloyable active material. Hence, the negative electrode current collector 10 may be partially melted at the interface between the negative electrode current collector 10 and the thin-film negative electrode active material layers 11. Also, the negative electrode lead 13 may be partially melted at the contact portion between the thin-film negative electrode active material layer 11 and the negative electrode lead 13. However, the region extending from the negative electrode current collector 10 to the negative electrode lead 13 via the thin-film negative electrode active material layer 11 is not melted. Even if ultrasonic welding is performed, the same phenomenon occurs as in resistance welding.

That is, according to resistance welding and ultrasonic welding, only the negative electrode current collector 10 and/or the negative electrode lead 13 is partially melted, and the thin-film negative electrode active material layers 11 are not melted. As such, the negative electrode current collector 10 and the negative electrode lead 13 cannot be connected. Even when they appear to be connected, disconnection tends to occur during battery fabrication and the like.

In the production method of the first embodiment, when the thin-film negative electrode active material layers 11 include a silicon-based active material, it is preferable to perform the step of causing the thin-film negative electrode active material layers 11 to absorb lithium (hereinafter referred to as “lithium absorption step”) between the step (1) and the step (2). This further promotes the uniform dispersion of the alloy in the alloy layer 24 obtained by the step (3).

Also, when the lithium absorption step is performed, the dimensions of the alloy layers 24 can be increased to such an extent that they do not interfere with the fabrication of a wound electrode assembly, without making the shape of the alloy layers 24 uneven, compared with when the lithium absorption step is not performed. As a result, the area of the alloy layers 24 in contact with the negative electrode current collector 10 and the negative electrode lead 13 is enlarged, thereby further increasing the adhesion and conductivity between the negative electrode current collector 10 and the negative electrode lead 13 connected by the alloy layers 24.

The absorption of lithium into the thin-film negative electrode active material layer 11 can be performed, for example, by vacuum deposition, an electrochemical method, affixing a lithium foil to a surface of the thin-film negative electrode active material layer 11, etc. For example, according to vacuum deposition, by disposing a lithium metal in the target of a vacuum deposition device and depositing it in a vacuum, lithium is absorbed in the thin-film negative electrode active material layer 11. While the amount of lithium absorbed is not particularly limited, it is preferably equivalent to the amount of irreversible capacity of the thin-film negative electrode active material layer 11.

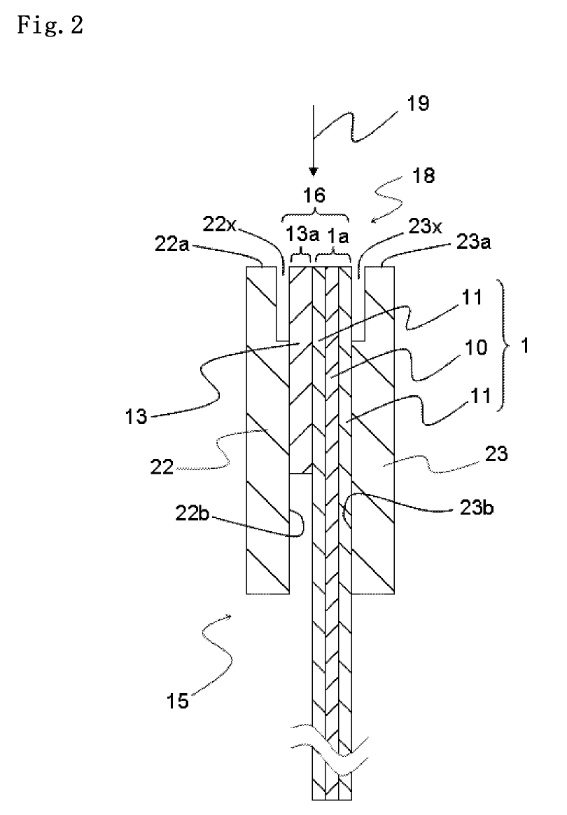

FIG. 2 is a longitudinal sectional view showing a method for producing a negative electrode for a lithium ion battery in a second embodiment of the invention. The method for producing a negative electrode for a lithium ion battery in the second embodiment (hereinafter referred to as the “production method of the second embodiment”) is similar to the production method of the first embodiment illustrated in FIG. 1. Thus, in FIG. 2, components corresponding to those of FIG. 1 are given the same reference characters as those of FIG. 1, with their descriptions omitted.

The production method of the second embodiment can be performed in the same manner as the production method of the first embodiment, except that welding jigs 15 are used in place of the welding jigs 14 in the step (2).

The welding jigs 15 comprise a first plate 22 and a second plate 23. The first plate 22 has a face 22b to mate with the second plate 23, and the second plate 23 has a face 23b to mate with the first plate 22. The mating faces 22b and 23b of the welding jigs 15 have, in at least a part of the area around the welding region, a shape which restricts expansion of the volume of the welding region due to arc discharge. The welding jigs 15 can be produced by shaping a metal material such as copper into a predetermined shape.

The welding jigs 15 of this embodiment have a depression 18 which is formed by a first recess 22x of the first plate 22 and a second recess 23x of the second plate 23 when the negative electrode plate 1 and the negative electrode lead 13 are clamped between the first plate 22 and the second plate 23. The space inside the depression 18 has a shape which restricts expansion of the volume of the welding region.

The first recess 22x is formed from an end face 22a of the first plate 22 along the mating face 22b. In this embodiment, the first recess 22x is a notch that is rectangular in a section. The section of the first recess 22x refers to a section in the thickness direction of the first plate 22. The second recess 23x is formed from an end face 23a of the second plate 23 along the mating face 23b, and faces the first recess 22x with the negative electrode plate 1 and the negative electrode lead 13 therebetween. In this embodiment, the second recess 23x is a notch that is rectangular in a section. The section of the second recess 23x refers to a section in the thickness direction of the second plate 23.

When each of the first recess 22x and the second recess 23x is a notch that is rectangular in a section, the dimensions of these notches are not particularly limited and can be selected as appropriate, depending on the thickness of the negative electrode current collector 10, the thin-film negative electrode active material layer 11, and the negative electrode lead 13, the kind and composition of the metal and semimetal elements contained therein, etc.

For example, when the negative electrode current collector 10 has a thickness of 1 to 50 μm, the thin-film negative electrode active material layer 11 has a thickness of 1 to 30 μm, and the negative electrode lead 13 has a thickness of 10 to 500 μm, the length along the end face 22a of the first plate 22 or the end face 23a of the second plate 23 in a section of the first recess 22x or the second recess 23x is preferably 0.1 to 0.6 mm, and the length along the mating face 22b of the first plate 22 or the mating face 23b of the second plate 23 in a section of the first recess 22x or the second recess 23x is preferably 0.2 to 0.6 mm. Also, it is preferable to form the first recess 22x and the second recess 23x so that they have the same dimensions.

The width of the depression 18 formed by the first recess 22x and the second recess 23x is almost constant. Thus, in this embodiment, the space inside the depression 18 is in the shape of a rectangular parallelepiped, and the space in the depression 18 is rectangular in a section. However, the space in the depression 18 may be in the shape of a cube, a cylinder, or the like.

The use of the welding jigs 15 can produce essentially the same effects as the use of the welding jigs 14.

According to the production methods of the first and second embodiments, a negative electrode with a thin-film negative electrode active material layer including an alloyable active material can be produced efficiently and industrially advantageously. In the production methods of the first and second embodiments, alloying occurs in the step (3), so the temperature at which the negative electrode current collector and the negative electrode lead are connected can be lowered. The production methods of the first and second embodiments are industrially advantageous also in this respect.

Also, in the production methods of the first and second embodiments, the first recess 20x and the second recess 21x have the same shape, and the first recess 22x and the second recess 23x have the same shape, but there is no limitation thereto. They may have different shapes.

FIG. 3 is a schematic longitudinal sectional view of the configuration of the lithium ion battery 25 in a third embodiment of the invention. The lithium ion battery 25 has the same configuration as conventional lithium ion batteries, except for the inclusion of the negative electrode 28 obtained by the production method of the first or second embodiment of the invention.

The lithium ion battery 25 of this embodiment, which includes the negative electrode 28, has a high capacity, a high output, and good battery performance such as output characteristics and cycle characteristics. Also, in the negative electrode 28, the negative electrode plate 1 (negative electrode current collector 10) and the negative electrode lead 13 are firmly connected by the alloy layers 24 with good conductivity. Therefore, the current collecting performance and output characteristics of the negative electrode 28 are maintained at a high level over an extended period of time, and the lithium ion battery 25 of this embodiment has a long service life.

The lithium ion battery 25 includes a wound electrode assembly 26, an upper insulator plate 30 and a lower insulator plate 31 fitted to both ends of the wound electrode assembly 26 in the longitudinal direction thereof, a battery case 32 for housing the wound electrode assembly 26 and the like, a seal plate 34 for sealing the battery case 32, a positive electrode terminal 33 supported by the seal plate 34, and a non-aqueous electrolyte (not shown).

The upper insulator plate 30 and the lower insulator plate 31 are fitted to both ends of the wound electrode assembly 26 in the longitudinal direction thereof, which is placed in the battery case 32. At this time, a positive electrode lead 36 of the positive electrode 27 and a negative electrode lead 13 of the negative electrode 28 are connected to predetermined positions, respectively. A non-aqueous electrolyte is injected into the battery case 32. The opening of the battery case 32 is then fitted with the seal plate 34 supporting the positive electrode terminal 33, and the open edge of the battery case 32 is crimped onto the seal plate 34 to seal the battery case 32. In this way, the lithium ion battery 25 can be obtained.

The wound electrode assembly 26 includes the positive electrode 27 shaped like a strip, the negative electrode 28 shaped like a strip, and a separator 29 shaped like a strip. The wound electrode assembly 26 can be produced by, for example, interposing the separator 29 between the positive electrode 27 and the negative electrode 28 and winding them, with one end in the longitudinal direction thereof as the winding axis. In this embodiment, the wound electrode assembly 26 is used, but there is no limitation thereto. It is also possible to use a flat electrode assembly produced by pressing the wound electrode assembly 26, a laminated electrode assembly produced by laminating the positive electrode 27, the negative electrode 28, and the separator 29 interposed therebetween, or the like.

The positive electrode 27 includes a positive electrode plate 35 and the positive electrode lead 36. The positive electrode plate 35 includes a positive electrode current collector and positive electrode active material layers.

The positive electrode current collector can be a porous or non-porous conductive substrate made of a metal material such as stainless steel, titanium, aluminum, or an aluminum alloy.

Examples of porous conductive substrates include mesh, net, punched sheets, lath, porous materials, foam, and non-woven fabric. Examples of non-porous conductive substrates include foil and films. While the thickness of the conductive substrate is not particularly limited, it is preferably 1 to 500 μm, and more preferably 10 to 30 μm.

In this embodiment, the positive electrode active material layer is provided on both surfaces of the positive electrode current collector in the thickness direction thereof, but there is no limitation; it may be provided on one surface of the positive electrode current collector in the thickness direction. The positive electrode active material layer includes a positive electrode active material, and may further include a conductive agent, a binder, etc.

Preferable examples of positive electrode active materials include lithium-containing composite metal oxides and olivine-type lithium phosphates.

Lithium-containing composite metal oxide is a metal oxide containing lithium and a transition metal element, or such metal oxides in which part of the transition metal element in the metal oxide is replaced with a different element. Examples of transition metal elements include Sc, Y, Mn, Fe, Co, Ni, Cu, and Cr, among which Mn, Co, and Ni are preferable. Examples of different elements include Na, Mg, Zn, Al, Pb, Sb, and B, among which Mg and Al are preferable. These transition metal elements and different elements may be used singly or in combination, respectively.

Examples of lithium-containing composite oxides include Li_{y}CoO₂, Li_{y}NiO₂, Li_{y}MnO₂, Li_{y}COₘNi₁₋ₘO₂, Li_{y}COₘA₁₋ₘOₙ, Li_{y}Ni₁₋ₘAₘOₙ, Li_{y}Mn₂O₄, Li_{y}Mn₂₋ₘAₙO₄ wherein A is at least one element selected from the group consisting of Sc, Y, Mn, Fe, Co, Ni, Cu, Cr, Na, Mg, Zn, Al, Pb, Sb, and B, 0<y≦1.2, m=0 to 0.9, and n=2.0 to 2.3.

Examples of olivine-type lithium phosphates include LiXPO₄ and Li XPO₄F wherein X is at least one element selected from the group consisting of Co, Ni, Mn, and Fe. In the above-listed positive electrode active materials, the molar ratio of lithium is a value immediately after the preparation of the positive electrode active material, and decreases and increases due to charge and discharge.

These positive electrode active materials can be used singly or in combination.

Examples of conductive agents include graphites such as natural graphite and artificial graphite, carbon blacks such as acetylene black, ketjen black, channel black, furnace black, lamp black, and thermal black, conductive fibers such as carbon fiber and metal fiber, metal powders such as aluminum, fluorinated carbon and the like. These conductive agents can be used singly or in combination.

The binder can be a resin material. Examples of resin materials include polyvinylidene fluoride, polytetrafluoroethylene, polyhexafluoropropylene, polyethylene, polypropylene, polyamide, polyimide, polyamide-imide, polyacrylonitrile, polymethyl acrylate, polyethyl acrylate, polymethyl methacrylate, polyethyl methacrylate, polyvinyl pyrrolidone, styrene butadiene rubber, modified acrylic rubber, carboxymethyl cellulose, copolymers containing two or more monomer compounds, and the like.

Examples of such monomer compounds include tetrafluoroethylene, hexafluoropropylene, pentafluoropropylene, perfluoroalkyl vinyl ether, vinylidene fluoride, chlorotrifluoroethylene, ethylene, propylene, acrylic acid, hexadiene, and the like.

These binders can be used singly or in combination.

The positive electrode active material layer can be formed, for example, by applying a positive electrode mixture slurry onto a surface of a positive electrode current collector to form a coating, drying the coating, and rolling it. The positive electrode mixture slurry can be prepared by dissolving or dispersing a positive electrode active material, a conductive agent, a binder, etc. in a dispersion medium. Examples of dispersion media include dimethylformamide, dimethylacetamide, methylformamide, N-methyl-2-pyrrolidone, dimethylamine, acetone, cyclohexanone, and the like.

One end of the positive electrode lead 36 is connected to the exposed portion of the positive electrode current collector, while the other end is connected to the positive electrode terminal 33, by resistance welding, ultrasonic welding, or the like. The positive electrode lead 36 is made of a material such as aluminum or an aluminum alloy. Examples of aluminum alloys include an aluminum-silicon alloy, an aluminum-iron alloy, an aluminum-copper alloy, an aluminum-manganese alloy, an aluminum-magnesium alloy, and an aluminum-zinc alloy.

The negative electrode 28 includes the negative electrode plate 1, the negative electrode lead 13, and a plurality of the alloy layers 24. The alloy layers 24 allow the negative electrode current collector of the negative electrode plate 1 and the negative electrode lead 13 to be connected with good conductivity. The negative electrode 28 is a negative electrode obtained by the production method of the first or second embodiment of the invention

The separator 29 is interposed between the positive electrode 27 and the negative electrode 28. The separator 29 can be a sheet with a predetermined ion permeability, a predetermined mechanical strength, and a predetermined insulating property. The separator 29 is preferably a porous sheet with pores, such as a microporous film, woven fabric, or non-woven fabric. While various resin materials can be used as the material for the separator 29, a polyolefin such as polyethylene or polypropylene is preferable in consideration of durability, shut-down function, etc.

The thickness of the separator 29 is preferably 10 to 300 μm, and more preferably 10 to 30 μm. Also, the porosity of the separator 29 is preferably 30 to 70%, and more preferably 35 to 60%. The porosity as used herein refers to the ratio of the total volume of the pores in the separator 29 to the volume of the separator 29.

The wound electrode assembly 26 is impregnated with a liquid non-aqueous electrolyte with lithium-ion conductivity. The liquid non-aqueous electrolyte includes a solute (supporting salt) and a non-aqueous solvent, and may include additives.

Examples of solutes include LiClO₄, LiBF₄, LiPF₆, LiAlCl₄, LiSbF₆, LiSCN, LiCF₃SO₃, LiCF₃CO₂, LiAsF₆, LiB₁₀Cl₁₀, lithium lower aliphatic carboxylates, LiCl, LiBr, LiI, LiBCl₄, borates, and imide salts. The solute is preferably dissolved in the non-aqueous solvent at a concentration of 0.5 to 2 mol/L.

Examples of non-aqueous solvents include cyclic carbonic acid esters, chain carbonic acid esters, cyclic carboxylic acid esters, and the like. Cyclic carbonic acid esters include propylene carbonate, ethylene carbonate, and the like. Chain carbonic acid esters include diethyl carbonate, ethyl methyl carbonate, dimethyl carbonate, and the like. Cyclic carboxylic acid esters include γ-butyrolactone, γ-valerolactone, and the like. These non-aqueous solvents can be used singly or in combination.

Examples of additives include additives which increase coulombic efficiency, such as vinylene carbonate, vinyl ethylene carbonate, and divinyl ethylene carbonate, and additives which inactivate batteries, such as cyclohexyl benzene, biphenyl, and diphenyl ether. These additives can be used singly or in combination.

The upper insulator plate 30, the lower insulator plate 31, and the seal plate 34 are produced by shaping an electrically insulating material, preferably a resin material or rubber material, into a predetermined shape. The battery case 32 is a cylindrical member with an opening at one end in the longitudinal direction and a closed bottom. The battery case 32 and the positive electrode terminal 33 are produced by shaping a metal material such as iron or stainless steel into a predetermined shape. Alternatively, it is also possible to use a seal plate made of a metal material, fit the seal plate to the opening of the battery case with a gasket therebetween, and crimp the open edge of the battery case onto the seal plate to seal the battery case. In this case, the other end of the positive electrode lead is connected to the seal plate.

The lithium ion battery 25 of this embodiment is a cylindrical battery including the wound electrode assembly 26, but there is no limitation thereto, and various forms can be used. Such examples include prismatic batteries, flat batteries, coin batteries, and laminated-film packed batteries.

The negative electrode obtained by the negative electrode production method of the invention can be used advantageously as the negative electrode for lithium ion batteries. Also, the lithium ion battery of the invention can be used in the same applications as those of conventional lithium ion batteries, and is particularly useful as the main power source or auxiliary power source for electronic devices, electrical appliances, machine tools, transport devices, power storage devices, etc. Examples of electronic devices include personal computers, cellular phones, mobile devices, personal digital assistants, portable game machines and the like. Examples of electric appliances include vacuum cleaners, video cameras and the like. Examples of machine tools include power tools, robots and the like. Examples of transport devices include electric vehicles, hybrid electric vehicles, plug-in HEVs, fuel cell cars and the like. Examples of power storage devices include uninterruptible power supplies and the like.

### Example

The invention is hereinafter described specifically by way of Examples and Comparative Examples.

### Example 1

### (1) Preparation of Positive Electrode Active Material

Cobalt sulfate was added to a nickel sulfate aqueous solution such that Ni:Co=8.5:1.5 (molar ratio) to prepare an aqueous solution with a metal ion concentration of 2 mol/L. While this aqueous solution was being stirred, a 2 mol/L aqueous solution of sodium hydroxide was added dropwise for neutralization, to obtain a ternary precipitate with the composition represented by Ni_{0.85}CO_{0.15}(OH)₂ by coprecipitation. This precipitate was filtered out, washed with water, and dried at 80° C. to obtain a composite hydroxide.

This composite hydroxide was heated at 900° C. in air for 10 hours, to obtain a composite oxide with the composition represented by Ni_{0.85}CO_{0.15}O₂. The composite oxide was mixed with lithium hydroxide monohydrate such that the sum of the number of Ni and Co atoms was equal to the number of Li atoms. The resultant mixture was heated at 800° C. in air for 10 hours, to obtain a lithium nickel containing composite metal oxide with the composition represented by LiNi0.85Co_{0.15}O₂. In this way, a positive electrode active material having a volume basis average secondary particle size of 10 μm was obtained.

### (2) Preparation of Positive Electrode

A positive electrode mixture slurry was prepared by sufficiently mixing 93 g of the positive electrode active material powder thus prepared, 3 g of acetylene black (conductive agent), 4 g of polyvinylidene fluoride powder (binder), and 50 ml of N-methyl-2-pyrrolidone. This positive electrode mixture slurry was applied onto both faces of a 15-μm thick aluminum foil (positive electrode current collector), and the resulting coating was dried and rolled to form a 50-μm thick positive electrode active material layer on each side. In this way, a positive electrode plate of 56 mm×205 mm was produced. A part (56 mm×5 mm) of the positive electrode active material layer on each side of the positive electrode plate was cut to form an exposed portion of the positive electrode current collector, to which an aluminum positive electrode lead was welded by ultrasonic welding, to obtain a positive electrode.

### (3) Preparation of Negative Electrode Plate

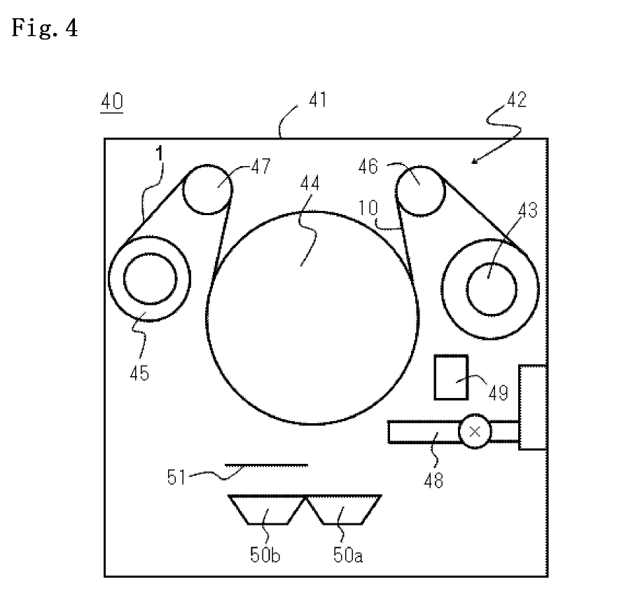

FIG. 4 is a side perspective view schematically showing the configuration of an electron beam vacuum deposition device 40. A vacuum chamber 41 is a pressure-resistant container, and includes transport means 42, gas supply means 48, plasma-generating means 49, silicon targets 50a and 50b, a shielding plate 51, and an electron beam generator (not shown).

The transport means 42 include a supply roller 43, a can 44, a take-up roller 45, and guide rollers 46 and 47. The strip-like negative electrode current collector 10 is wound around the supply roller 43. The strip-like negative electrode current collector 10 is transported via the guide roller 46, the can 44, and the guide roller 47, and rewound by the take-up roller 45 as the negative electrode plate 1.

When the strip-like negative electrode current collector 10 is transported over the surface of the can 44, silicon vapor is supplied to the surface of the strip-like negative electrode current collector 10. The silicon vapor is cooled by cooling means (not shown) inside the can 44, so that it is deposited on the surface of the strip-like negative electrode current collector 10 to form a solid film serving as the thin-film negative electrode active material layer 11. The silicon vapor is produced by irradiating the silicon targets 50a and 50b with an electron beam from the electron beam generator.

The gas supply means 48 supplies a raw material gas into the vacuum chamber 41. When the raw material gas is oxygen, a mixture of silicon vapor and oxygen is supplied to the surface of the strip-like negative electrode current collector 10, so that the thin-film negative electrode active material layer 11 comprising a silicon oxide is formed. When the gas supply means 48 supplies no raw material gas, the thin-film negative electrode active material layer 11 including silicon is formed. The plasma-generating means 49 makes the raw material gas into plasmatic condition. The horizontal position of the shielding plate 51 is adjusted depending on the condition of the thin-film negative electrode active material layer 11 being formed on the surface of the negative electrode current collector 10.

Using the deposition device 40, a 5-μm thick thin-film negative electrode active material layer (silicon thin film) was formed on both surfaces of the strip-like negative electrode current collector 10 under the following conditions to produce a negative electrode plate.

Pressure inside vacuum chamber: 8.0×10⁻⁵ Torr

Strip-like negative electrode current collector: surface-roughened electrolytic copper foil (available from Furukawa Electric Co., Ltd.)

Rewinding speed of strip-like negative electrode current collector by take-up roller: 2 cm/min

Raw material gas: not supplied

Silicon target: silicon monocrystal with a purity of 99.9999% (available from Shin-Etsu Chemical Co., Ltd.)

Acceleration voltage of electron beam: −8 kV

Emission of electron beam: 300 mA

The negative electrode plate thus obtained was cut to 58 mm×210 mm. The negative electrode plate was secured in a resistance heating deposition device (available from ULVAC, Inc.) so that a tantalum board and the thin-film negative electrode active material layer faced each other. The tantalum board was charged with lithium metal. An argon atmosphere was introduced into the resistance heating deposition device, and a current of 50 A was passed through the tantalum board to deposit lithium onto the thin-film negative electrode active material layer. The deposition time was set to 10 minutes. In this way, lithium in an amount equivalent to the irreversible capacity stored during the initial charge/discharge was added to the thin-film negative electrode active material layer on both surfaces.

### (4) Welding of Negative Electrode Lead

The negative electrode plate thus obtained was connected with a negative electrode lead, which was prepared by cutting a copper foil (trade name: HCL-02Z, available from Hitachi Cable Ltd.) to a width of 5 mm, a length of 70 mm, and a thickness of 26 μm, by plasma welding as follows, to produce a negative electrode.

First, the negative electrode plate and the negative electrode lead were laminated so that an end face of the negative electrode plate in the longitudinal direction and an end face of the negative electrode lead in the width direction formed a continuous flat plane, i.e., a flat welding end face. They were disposed so that the direction perpendicular to the welding end face agreed with the vertical direction, and that the welding end face faced upward in the vertical direction. They were clamped between a pair of welding jigs illustrated in FIG. 1, and secured by a single axis robot (available from LAI Corporation).

The welding jigs comprised a first plate and a second plate. The first plate and the second plate each had a size of 100 mm×40 mm×10 mm and were made of copper. The first recess formed in the first plate and the second recess formed in the second plate were tapered (in the shape of a right-angled triangle) in a section. In a section of these recesses, the length along the end face of the first plate or the second plate was 0.1 mm, and the length along the mating face of the first plate or the second plate was 0.4 mm.

Subsequently, a plasma welding machine (trade name: PW-50NR, available from KOIKE SANSO KOGYO Co. Ltd.) was disposed vertically above the welding end face. Energy was applied perpendicularly to the welding end face from the torch of the plasma welding machine. The torch was moved at equal intervals in the width direction of the negative electrode plate. From the places where the torch was stopped, energy was applied to the welding end face under the following conditions to form alloy layers. In this way, a negative electrode was produced.

Electrode rod: diameter 1.0 mm

Electrode nozzle: diameter 1.6 mm

Torch distance: 2.0 mm

Torch sweep speed: 30 mm/s

Plasma gas: argon

Plasma gas flow rate: 100 (sccm)

Shielding gas: hydrogen and argon

Shielding gas flow rate (hydrogen): 500 (sccm)

Shielding gas flow rate (argon): 1 (slm)

Welding current: 8.0 A

After the plasma welding, the negative electrode plate thus obtained was allowed to cool naturally and the welding end face was observed with a scanning electron microscope (trade name: 3D Real Surface View, available from Keyence Corporation). The result confirmed that a plurality of alloy layers were formed between the negative electrode current collector and the negative electrode lead. Also, in a section of these alloy layers in the thickness direction of the negative electrode plate, the largest thickness was 0.3 mm. Thus, compared with the total thickness 0.17 mm of the negative electrode plate and the negative electrode lead before the plasma welding, the amount of increase in the thickness was 0.13 mm. In a section of the alloy layers, the shape of the alloy layers was very close to a rectangle and had no partially protruding portions.

The scanning electron microscope (3D Real Surface View) was fitted with an energy dispersive X-ray analyzer (trade name: Genesis XM2, available from EDAX), and a section of the alloy layers was analyzed to obtain an elemental map of copper and silicon. As a result, copper and silicon were present in almost the whole region of the section of the alloy layers. Also, using the energy dispersive X-ray analyzer (Genesis XM2), the elemental molar ratio of copper to silicon was measured in a predetermined portion of the alloy layers. As a result, copper accounted for 90 mol % and silicon accounted for 10 mol %. These results showed that silicon was diffused in copper to form an alloy.

A section of the alloy layers was qualitatively analyzed by a micro diffractometer (trade name: RINT 2500, available from Rigaku Corporation). As a result, a peak attributed to copper and peaks attributed to Cu₅Si were identified from the alloy layers. Therefore, the alloy layers were found to include a Cu₅Si alloy.

Further, a section of the alloy layers was analyzed by an Auger electron spectrometer (trade name: MODEL670, available from ULVAC PHI) to obtain an elemental map of lithium. On the periphery of the section of each alloy layer, there were sections of the thin-film negative electrode active material layer and sections of the silicon layer, both of which were very small compared with the section of the alloy layer. The thin-film negative electrode active material layer was a portion which remained unmelted. The silicon layer is a portion which was melted and resolidified without being alloyed. Although lithium was present in these sections, no lithium was present in the sections of the copper and the copper alloy.

These analysis results showed that copper and a copper-silicon alloy including Cu₅Si were present in the alloy layer and that silicon and lithium were present on the periphery of the section of the alloy layer.

### (5) Production of Battery

A wound electrode assembly was produced by interposing a polyethylene micro-porous film (separator, trade name: Hipore, thickness 20 μm, available from Asahi Kasei E-materials) between the positive electrode and the negative electrode obtained in the above manner and winding them. The other end of the positive electrode lead was welded to a seal plate (stainless steel positive electrode terminal), while the other end of the negative electrode lead was connected to the inner face of the bottom of a cylindrical battery case made of iron. The ends of the wound electrode assembly in the longitudinal direction were fitted with an upper insulator plate and a lower insulator plate which are made of polyethylene, and this was placed in the battery case.

Subsequently, a non-aqueous electrolyte, which was prepared by dissolving LiPF₆ at a concentration of 1.0 mol/L in a solvent mixture of ethylene carbonate and ethyl methyl carbonate in a volume ratio of 1:1, was injected into the battery case. Further, the opening of the battery case was fitted with a seal plate with a polyethylene gasket therebetween, and the open edge of the battery case was crimped inward to seal the battery case, thereby producing a cylindrical lithium ion battery.

### Comparative Example 1

A cylindrical lithium ion battery was produced in the same manner as in Example 1 except for the use of a negative electrode prepared in the following manner using a pair of welding jigs comprising a first plate and a second plate which were copper plates (100 mm×40 mm×10 mm) whose mating faces were flat without any notches (the first recess and the second recess).

### [Preparation of Negative Electrode]

A negative electrode plate with lithium deposited thereon which was prepared in the same manner as in Example 1 and a negative electrode lead prepared in the same manner as in Example 1 were laminated and clamped between the first plate and the second plate of the above-mentioned welding jigs. At this time, an end face of the negative electrode plate in the longitudinal direction and an end face of the negative electrode lead in the width direction formed a continuous flat plane, i.e., a welding end face, and the welding end face faced upward in the vertical direction. Also, the welding end face protruded vertically upward by 0.5 mm from the end faces of the first plate and the second plate facing upward in the vertical direction. The welding end face was subjected to a plasma welding in the same manner as in Example 1, to prepare a negative electrode.

After the plasma welding, the negative electrode thus obtained was allowed to cool naturally and the welding end face was observed with a scanning electron microscope (trade name: 3D Real Surface View, available from Keyence Corporation). As a result, in a section of the alloy layers in the thickness direction of the negative electrode plate after the plasma welding, the largest thickness was 0.9 mm. Thus, compared with the total thickness 0.17 mm of the negative electrode plate and the negative electrode lead before the plasma welding, the amount of increase in the thickness was 0.73 mm. In a section of the alloy layers, the shape of the whole alloy layers was very close to a semicircle, which protruded relatively largely compared with the surface of the negative electrode plate.

### Comparative Example 2

A cylindrical lithium ion battery was produced in the same manner as in Example 1, except that the negative electrode lead was connected to the negative electrode current collector by resistance welding instead of plasma welding to prepare a negative electrode. The negative electrode was prepared as follows.

### [Preparation of Negative Electrode]

First, a negative electrode plate prepared in the same manner as in Example 1 and a negative electrode lead made of copper foil (width 4 mm, length 70 mm, thickness 100 μm) were disposed adjacent to each other so that an end face of the negative electrode plate in the longitudinal direction and an end face of the negative electrode lead in the width direction formed a continuous flat plane. These negative electrode plate and negative electrode lead were clamped between electrode rods with a tip diameter of 2 mm, and spot-welded using a resistance welding machine (available from Miyachi Corporation) with the current value set to 1.3 kA, to prepare a negative electrode.

### (Evaluation)

Using the negative electrodes prepared in Example 1 and Comparative Examples 1 to 2, the following evaluation test was performed.

### [Bonding Strength Between Negative Electrode Current Collector and Negative Electrode Lead]

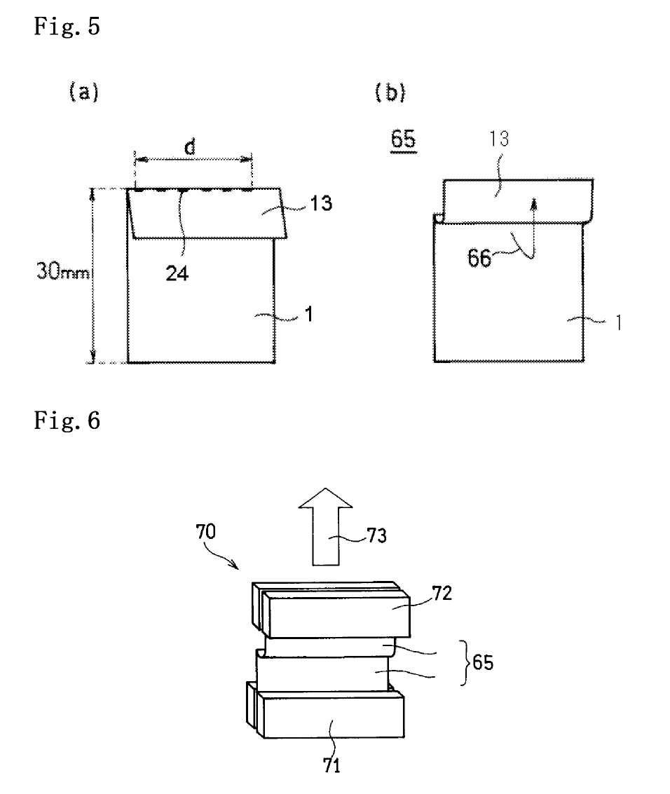

Using the negative electrodes prepared in Example 1 and Comparative Examples 1 to 2, the bonding strength between the negative electrode current collector and the negative electrode lead was measured as the tensile strength of the negative electrode lead from the negative electrode current collector. FIG. 5 is a perspective view showing a method for preparing a sample 65 which is used to measure the tensile strength of the negative electrode lead 13 from the negative electrode current collector 10. FIG. 6 is a perspective view showing a method for measuring the tensile strength of the negative electrode lead 13 from the negative electrode current collector 10.

As illustrated in FIG. 5(a), first, the negative electrode lead 13 was cut such that the length of the negative electrode lead 13 was equal to the width of the negative electrode plate 1. Then, the negative electrode plate 1 was cut such that the length of the negative electrode plate 1 was 30 mm from the end to which the negative electrode lead 13 was connected. At this time, the connection width d was measured. The connection width d is the length of the alloy layers 24 in the width direction of the negative electrode plate 1.

When a plurality of the alloy layers 24 are formed at predetermined intervals as illustrated in FIG. 5(a), the connection width d refers to the length from the alloy layer 24 formed at one end in the width direction of the negative electrode plate 1 to the alloy layer 24 formed at the other end in the width direction of the negative electrode plate 1. In this case, the connection width d includes the length of the alloy layer 24 formed at one end and the length of the alloy layer 24 formed at the other end. In the negative electrodes produced in Example 1 and Comparative Examples 1 to 2, the connection width d was 30 mm. Subsequently, as illustrated in FIG. 5(b), the negative electrode lead 13 was folded back in the direction of an arrow 66 so as to separate from the negative electrode plate 1. In this way, the sample 65 for measuring tensile strength was prepared.

The sample 65 obtained in the above was used to measure a tensile strength by the measurement method illustrated in FIG. 6. The end portion of the negative electrode plate 1 where no alloy layers 24 were formed was clamped and fixed by a lower cramping jig 71 of a universal tester (available from Shimadzu Corporation) 70, while the end portion of the negative electrode lead 13 (the end portion in the folded side) where no alloy layers 24 were formed was clamped and fixed by an upper cramping jig 72.

At a room temperature of 25° C., the upper cramping jig 72 was moved at a speed of 5 mm/min in the direction of an arrow 73 to pull the negative electrode lead 13 and measure the tensile strength (N) when the connected portion (alloy layers 24) of the negative electrode plate 1 and the negative electrode lead 13 broke. From the measured value of tensile strength and the measured value of connection width d, the tensile strength (N/mm) per 1 mm of the connection width was determined. The results are shown in Table 1.

### [Conductivity Between Negative Electrode Current Collector and Negative Electrode Lead]

Using the negative electrodes prepared in Example 1 and Comparative Examples 1 to 2, the resistance between the negative electrode current collector and the negative electrode lead connected was measured as follows. The thin-film negative electrode active material layer in the vicinity of the negative electrode lead was removed with sandpaper. The resistance between the exposed negative electrode current collector and the negative electrode lead connected was measured with a milliohm meter (trade name: Milliohm HiTester 3540, available from Hioki E.E. Corporation). The results are shown in Table 1.

TABLE 1

| | Tensile | Tensile | Conductivity |
|---|---|---|---|
| | strength (N) | strength (N/mm) | (mΩ) |
| Example 1 | 55 | 1.8 | 0.9 |
| Comp. Example 1 | 58 | 1.9 | 0.9 |
| Comp. Example 2 | 0.5 | — | Not measurable |

The results of Example 1 in Table 1 show that the alloy layers can connect the negative electrode current collector and the negative electrode lead so that they have good adhesion and conductivity therebetween. Although the negative electrode current collector and the negative electrode lead in Comparative Example 1 also had good adhesion and conductivity therebetween, the alloy layers of Comparative Example 1 had a larger shape than the alloy layers of Example 1. Thus, when a wound electrode assembly was fabricated, extra effort was necessary to make the shape and dimensions of the wound electrode assembly within specs.

Further, when the negative electrode including the alloy layers of Comparative Example 1 are used to produce a battery, it is necessary to provide the battery with an inner space for preventing problems such as internal short-circuits. This is disadvantageous to high density design and high capacity design which need to minimize extra space inside a battery.

In Comparative Example 2 in which resistance welding was performed, it is clear that conductive connections were not formed. This indicates that resistance welding cannot connect the negative electrode lead to the negative electrode current collector.

### [Cycle Characteristics]

Each of the lithium ion batteries of Example 1 and Comparative Examples 1 to 2 was placed in a constant temperature oven of 20° C. The batteries were charged at a constant current and a constant voltage as follows.

Each battery was charged at a constant current of 1 C rate (1 C is the current value at which the whole battery capacity can be used up in 1 hour) until the battery voltage reached 4.2 V. After the battery voltage reached 4.2 V, each battery was charged at a constant voltage of 4.2 V until the current value reached 0.05 C. Then, after a 20-minute interval, the charged battery was discharged at a constant current of 1 C rate, which is a high rate, until the battery voltage reached 2.5 V. This charge/discharge cycle was repeated 100 times.

The percentage of the whole discharge capacity at the 100^{th} cycle relative to the whole discharge capacity at the 1^{st} cycle was calculated and used as capacity retention rate (%). The results are shown in Table 2.

TABLE 2

| | Capacity retention rate (%) |
|---|---|
| Example 1 | 82 |
| Comp. Example 1 | 81 |
| Comp. Example 2 | 0 |

It has been found that the batteries of Example 1 and Comparative Example 1 have high capacity retention rates and good cycle characteristics. However, a current did not flow through the battery of Comparative Example 1, with the resistance being infinite. This is probably because the lead became detached from the thin-film negative electrode active material layer during the battery fabrication.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A method for producing a negative electrode for a lithium ion battery, comprising the steps of:
(1) preparing a negative electrode plate and a negative electrode lead to be connected to the negative electrode plate, the negative electrode plate comprising a current collector and a thin-film negative electrode active material layer that is formed on a surface of the current collector and includes an alloyable active material;
(2) clamping the negative electrode plate and the negative electrode lead between a pair of welding jigs comprising a first plate and a second plate, in such a manner that a surface of the thin-film negative electrode active material layer and a surface of the negative electrode lead overlap and that a welding region including a welding end face comprising an end face of the negative electrode plate and an end face of the negative electrode lead is exposed; and
(3) generating an arc discharge toward the welding region to melt the welding region and connect the current collector and the negative electrode lead by arc welding,
wherein mating faces of the first plate and the second plate of the welding jigs have, along the welding region, a shape which restricts expansion of the volume of the welding region due to the arc discharge.

2. The method for producing a negative electrode for a lithium ion battery in accordance with claim 1,
wherein the welding jigs have a depression which is formed when the negative electrode plate and the negative electrode lead are clamped between the first plate and the second plate, the depression including a first recess formed from an end face of the first plate along the mating face thereof and a second recess formed from an end face of the second plate along the mating face thereof, the second recess facing the first recess, and
the depression has a shape which restricts expansion of the volume of the welding region.

3. The method for producing a negative electrode for a lithium ion battery in accordance with claim 2, wherein the depression is triangular or trapezoidal in a section.

4. The method for producing a negative electrode for a lithium ion battery in accordance with claim 3,
wherein the first recess is tapered in a section in the thickness direction of the first plate,
the second recess is tapered in a section in the thickness direction of the second plate, and
the width of the depression decreases as the distance from the end face of the first plate and the end face of the second plate increases.

5. The method for producing a negative electrode for a lithium ion battery in accordance with claim 2, wherein the depression is quadrangular in a section.

6. The method for producing a negative electrode for a lithium ion battery in accordance with claim 5,
wherein the first recess is quadrangular in a section in the thickness direction of the first plate, and
the second recess is quadrangular in a section in the thickness direction of the second plate.

7. The method for producing a negative electrode for a lithium ion battery in accordance with claim 1,
wherein the negative electrode lead comprises at least one metal or alloy selected from the group consisting of nickel, nickel alloys, copper, and copper alloys.

8. The method for producing a negative electrode for a lithium ion battery in accordance with claim 1,
wherein the alloyable active material is a silicon-based active material.

9. The method for producing a negative electrode for a lithium ion battery in accordance with claim 1, wherein the arc welding is plasma welding or TIG welding.

10. A lithium ion battery comprising:
a positive electrode comprising a positive electrode current collector, a positive electrode active material layer formed on a surface of the positive electrode current collector, and a positive electrode lead connected to the positive electrode current collector;
a negative electrode produced by the method of claim 1;
a separator interposed between the positive electrode and the negative electrode; and
a lithium-ion conductive non-aqueous electrolyte.
